(19) United States
(12) Patent Application Publication
(10) Pub. No.: US 2007/0263919 A1
(43) Pub. Date: Nov. 15, 2007

(54) DEVICE AND METHOD FOR DETECTING OBJECTS ON SEWING MACHINES

(75) Inventor: Michael Wentkowski, Wigoltingen (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: BERNINA INTERNATIONAL AG, Steckborn (CH)

(21) Appl. No.: 11/733,824

(22) Filed: Apr. 11, 2007

(30) Foreign Application Priority Data
May 10, 2006 (CH) 00772/06

(51) Int. Cl. G06K 9/00

(52) U.S. Cl. 382/141

(57) ABSTRACT

A device and the method for detecting objects on sewing machines (1) using one or more color sensors (25) in order to detect the colors of objects or of color marks (26) applied on the objects is provided. Such color marks (26) require only little space and can be applied even on very small parts. In a memory (59) accessible by the sewing machine control (57) clear allocations of colors and the respective objects are stored. According to the detected objects connected to the sewing machine (1), the operation of the sewing machine control (57) can be adjusted.

### BACKGROUND

The invention is directed to a device and a method for detecting objects on sewing machines as well a sewing machine objects detectable by said device.

Sewing machines generally comprise a multitude of parts, which can be coupled detachably to the machine. Examples here are sewing needles, pressure feet, stitching plates, hook housings, lower thread bobbins, embroidery frames and the like. Certain combinations of such parts are not permissible or cause a limitation of the operation of the sewing machine. For example, a triple needle may only be used together having a stitching plate with an appropriately wide stitching hole, and for certain sewing needles and/or pressure feet it is necessary to limit the pivotal range of the needle rod for creating zigzag stitches or to completely prevent such pivotal motions.

From prior art several ways are known to address this problem. For example, the components connected to the machine can be selected by a menu-controlled user interface and/or forwarded to the sewing machine control. In a memory of the control the permissible combinations and, if applicable, the necessary limitations of the range of values for the motions to be performed are stored. According to the manually provided components the control then automatically determines the permissible value ranges and/or generates warnings. The manual input of connected sewing machine elements carries the danger of faulty data input.

From JP9056963 it is known to engrave barcodes into sewing needles via laser beams, which then can be used to identify these needles. Here, expensive optic barcode scanners are necessary. JP9056963 provides no indications that such scanners can be arranged on a sewing machine. The high costs and the space needed for such scanners render the arrangement of such devices at a sewing machine unlikely.

From DE 19646707 A1 it is known to apply a unique bobbin mark in the form of a barcode on a lower thread bobbin. When wrapping a thread on a spool, data such as the spooling date or the length of the thread, is stored referenced to the data of the barcode. When inserting the spool into the sewing machine the barcode is detected by a barcode scanner and the allocated stored data is further processed. The purpose of this arrangement and the method is to allow a continuous documentation of the data regarding the lower thread.

DE 102005007007 shows a possibility to detect sewing machine parts using a camera with an added image processing unit. In such an arrangement with an appropriate spatial resolution the camera can simultaneously supervise several sewing machine parts.

Similar to the detection of sewing machine parts for ensuring a flawless cooperation of these parts, features of the sewing material and the lower and upper threads can be detected and used to ensure a flawless sewing quality. In order to process a certain material, suitable thread qualities, in particular suitable thread colors, must be determined by the user. In bobbins for lower threads it is possible to have threads of different quality and color (not visible for the user at least during the sewing process). Therefore, when sewing, for example the thread color can be changed suddenly or the end of the lower thread can be reached.

### SUMMARY

It is therefore the object of the present invention to provide a device and a method, by which in a relatively simple and cost effective way, an identification and/or characterization of features of sewing machine elements or sewing elements is possible. Another object of the invention comprises preventing mistakes that might develop in connection with the detected sewing machine parts or sewing elements.

These objects are attained by a device and a method for detecting objects on sewing machines as well as sewing machine objects detectable by this device according to the invention.

Using the device according to the invention and the method according to the invention, sewing machine parts and/or sewing elements can be identified using their color or using a color code. Appropriate data for reference colors can be stored in a storage device accessible by the control of the sewing machine, for example. A detection of object colors is also possible independent from the stored reference colors. Detected colors can influence the control of the sewing machine. The category of sewing elements and/or sewing objects comprises the sewing material and the threads used for processing the sewing material both before and after processing. The category sewing machine parts, in the following also called sewing machine objects, comprises all parts and/or accessories that can be connected to the sewing machine in a detachable manner or can be brought into an effective connection. The detection of the color and/or the color code preferably occurs via a programmable integrated electronic circuit, and here several photo-diodes with different color filters and an evaluation electronic can be integrated monolithically on a single common chip. Such a circuit arrangement is known from the data sheet “TCS230, programmable color light-to-frequency converter” (TAOS046-January 2003) of Texas Advanced Optoelectronic Solutions Inc., for example. A similar sensor is offered by the company Agilent under the name HDJD-S722-QR999. Such devices for the detection of colors can be produced cost-effectively and on the most limited space, even when they comprise an additional display optic and additional color filters for blocking the infrared component as well as a light source. Depending on the display optic selected, they can display on the light-sensitive sensor surface small areas of a size approximately 1 mm² or less up to larger areas of a size approximately 10 cm² or more. The distance of the object to be respectively detected can range, depending on the respective display optic, from approximately 1 mm to clearly more than 10 cm. In contrast to cameras, color sensors comprise no means for the spatial and/or local resolution of a two-dimensional image. A color sensor generally comprises several light-sensitive elements with spectral sensitivities for one each of the elementary colors red, green, and blue. The spectral sensitivities of each of the sensor elements can be achieved by color filters located in front thereof, for example. The sensor elements arranged spatially distributed with identical spectral sensitivities are each collected and jointly evaluated. In this way, local inconsistencies can be compensated. Furthermore, the sensitivity is increased in reference to an individual sensor element and the sensitivity can be reduced in reference to small changes of the position of the object to be detected. The color sensor provides at the output analog or digital color information of the entire detected range of the object.

The light necessary for detecting object colors can be created by one or more light sources. In particular, natural daylight of the sun, the light of artificial light sources with suitable spectral distribution in the area surrounding the sewing machines or the light of artificial light sources in the proximity of sewing machines can be used.

Instead of a direct object display on the spectrally sensitive sensor element via lenses, mirrors, or the like, light conductors can also be used, here, to conduct light from the sewing machine object and/or sewing object to be respectively detected to the sensor. The integrated color sensor comprises in addition to the photodiodes with various color filters also those without color filters. Preferably, a device with a white LED is provided for illuminating the objects to be detected. Particularly advantageous are so-called True White LED, in which an ultra-violate LED is used to excite RGB-phosphorus, as offered by Toyoda Gosei under the part number E1S40-lWOC6-01, for example. They create a particularly bright light with its spectrum being very similar to natural daylight in its spectral distribution. The illuminating device may comprise lenses and/or light conductors.

Instead of a white light source, three light sources that can be controlled independently from each other can be used with the colors red, green, and blue for illuminating object. When simultaneously three light sources are used white light can be created. Alternatively, the three light channels can also be addressed separately. When addressing the three light sources alternating in a rapid succession, it is possible to waive color sensors on color templates and to forward the output of the spectrally broadband, light sensitive elements to the three evaluation channels in a chronological manner. The sewing machine objects to be detected are each embodied in certain colors or comprise color marks and/or color codes or areas having one or more color points. The color codes on the individual objects are arranged such, when correctly connection to the sewing machine, they can be detected by respectively allocated color sensors. Additionally, means can be provided preventing the detection of color marks, e.g., when the marked objects are not correctly connected to the sewing machine or not connected at all, e.g., with elastic covers or flaps made from plastic or metal covering the color marks and, in case of a correct assembly at the sewing machine, release them via corresponding mechanical stops.

In order to detect each of the objects to be detected, an individual detection device may be provided, with it being allocated as close as possible to the object to be detected. A detection device may also comprise switchable optical elements or other means, which allow the sequential detection of color marks of several objects via only one centrally arranged color sensor. In a suitable selection of colors several objects and/or color marks may also be detected simultaneously by only one color sensor.

The color sensors and/or the corresponding display optics and/or light conductors and/or parts thereof may be arranged on the sewing machine in a fixed or mobile manner.

The detection device comprises a target size or comparison memory in which the colors that can be detected by the machine and/or its digitized equivalents are stored and/or can be stored.

Using the colors and/or color marks or color codes detected by one or more color sensors, the sewing machine control detects sewing machine objects and/or sewing objects connected to the sewing machine and executes the accordingly adjusted control algorithms. The processing instructions or functions necessary here are stored in a memory accessible by the sewing machine control.

By the detection device cooperating with the color sensor or sensors operating, supervising, or controlling tasks can be automated, simplified, or improved. In particular, it is possible to detect errors and potential conflicts. When such errors or conflicts occur warnings can be given or the execution of certain subsequent operations can be prevented. The device thus helps to prevent accidents and to ensure or improve the quality of a sewing process.

The color sensors can also be used for predetermining and/or programming reference criteria for the memory of the target parameters. Alternatively or additionally such color features can also be entered into the parameter memory via an interface.

### BRIEF DESCRIPTION OF THE DRAWINGS

In the following, using some figures, the invention is explained in greater detail. Shown are:

FIG. 1 is a side view of a sewing machine,

FIG. 2 is an exploded view of a part of the hook with the bobbin housing and lower thread bobbin,

FIG. 3is a view of a stitching plate,

FIG. 4 I a view of a sewing machine with a sliding and/or sewing table,

FIG. 5 is a detail view of a sewing machine with an attached embroidery module in the area of the lower arm,

FIG. 6 is a view of a pressure foot,

FIG. 7 is a detail view of a sewing machine in the area of the sewing needle and the pressure foot,

FIG. 8 is a view of a pressure foot with an integrated color sensor,

FIG. 9 is a view of a light conductor bundle,

FIG. 10 is a view of an arrangement with bilaterally spliced light conductor bundle for detecting color marks at several objects,

FIG. 11 is a perspective view of a domestic sewing machine with a thread bobbin carousel with a connected spare bobbin holder.

### DETAILED DESCRIPTION OF THE PREFERRED EMBODIMENTS

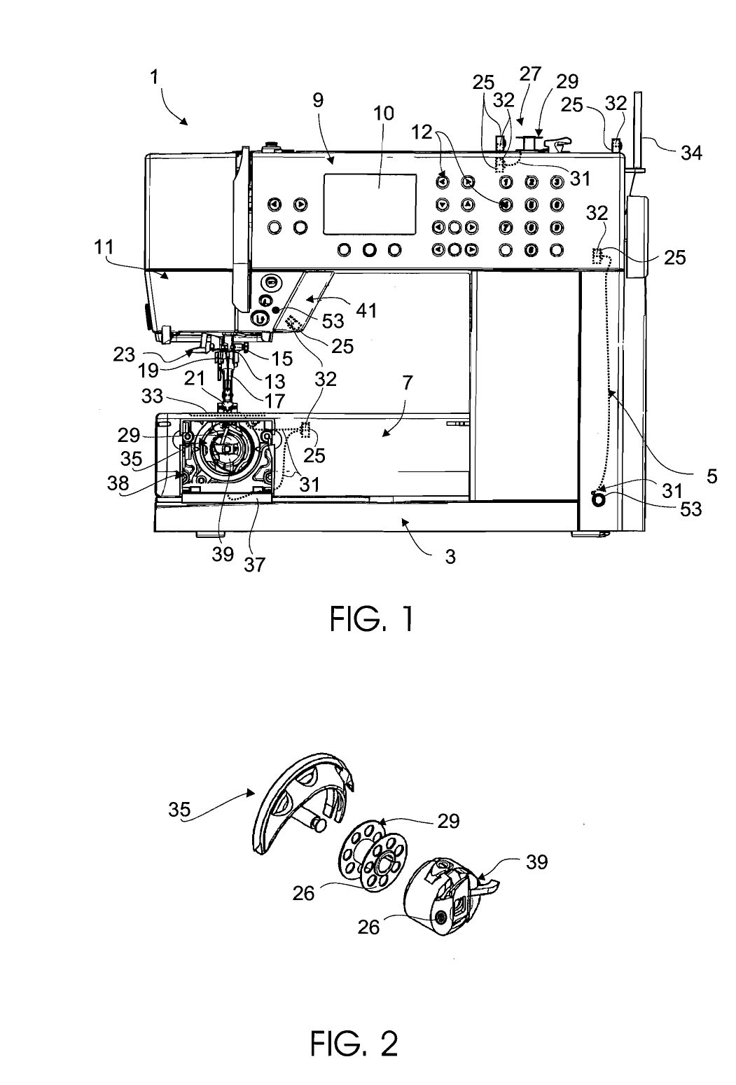

FIG. 1 shows schematically a sewing machine 1 with a base 3, a supporting stand 5 mounted on the base 3, and a free and/or lower arm 7 mounted thereto as well as an upper arm 9. On a side of the upper arm 9, a display 10 and/or a monitor and operating elements 12 are arranged. The front end of the upper arm 9 is embodied as a sewing machine head 11. On the underside of the sewing machine head 11, a needle rod 13 protrudes with a needle holder 15, a sewing needle and/or needle 17 inserted in the needle holder 15, a pressure foot holder 19 with a pressure foot 21 inserted therein, and a threading device 23. The sewing machine 1 comprises color sensors 25 at several places, some of which are shown exemplarily in FIG. 1. The color sensors 25 are here embodied to detect light dispersed within the respective detective area on sewing machine objects or sewing objects and/or at respective color marks 26. The light can be created by one or more light sources 32. Depending on the type of the respective color sensor 25, natural daylight and/or the light of artificial light sources in the room in which the sewing machine 1 is located and/or the light of light sources 32 at the sewing machine 1 can be used to illuminate the objects to be detected. In particular, such light sources 32 can be arranged in the area of the color sensors 25 or integrated together with them in common housings. The detection areas are determined by optic elements, such as lenses, mirrors, light conductors, and the like or codetermined by them. In the example shown in FIG. 1, one of the color sensors 25 is arranged at the side of a thread winding device 27 extending laterally upwards at the upper arm such that it can detect the thread color of the thread wound between the spool flanges on the shaft of the lower thread bobbin 29 placed on the mandrel of the thread winding unit 27. Another color sensor 25 is integrated in the upper arm 9 of the sewing machine 1 and detects the color of one of the bobbin flanges and/or a color mark 26 applied to an exterior of the bobbin flange via a light conductor 31 and/or a light conductor bundle 31. Another color sensor 25 extends upwards at the upper arm 9 of the sewing machine 1. It is arranged such that its imaging and/or detection optic 24 is aligned towards the mandrel of a thread spool holder 34. In the upper thread bobbin placed on the thread spool holder 34 this color sensor 25 can detect the color of the thread spooled onto it. When during the sewing process the thread supply is about to run out, the color sensor 25 additionally detects the color of the body of the spool. The color change detected by the color sensor 25 is therefore an indicator for the end of the thread approaching soon. In case of a missing upper thread spool, with an appropriately large detection area, the color of the thread spool holder 34 can be detected. With a respective coloring of the thread spool holder 34, the missing of the upper thread spool can be detected.

Another color sensor 25 is integrated in the lower arm 7. It comprises two light conductor bundles 31, which alternating can be connected for example with integrated optic circuit elements (not shown) and light-sensitive areas of the color sensor 25. One of these optic fiber bundles 31 ends below the stitching plate 33 and can detect a color mark 26 applied to its bottom. The other optic fiber bundle 31 ends at the interior side of a flap 37, which serves to open and close a hook housing 38. From here, the color of the bobbin capsule 39 or a color mark 26 applied thereupon is detected, as shown in the exploded representation of a part of a hook 35 with a bobbin capsule 39 and lower thread bobbin 29.

In the upper arm 7 or generally at any suitable place in or at the sewing machine housing, additional color sensors 25 can be arranged. They can for example serve to detect the color of the lower thread inside the hook housing 38 or the color of a color mark 26 embodied at a flange of the lower thread bobbin 29. Using the example of FIG. 2, the color mark 26 is embodied at the spool capsule 39 as a colored spot. In the lower thread bobbin 29, the entire perforated flange is embodied as a color mark 26.

In the example shown in FIG. 1, another color sensor 25 is arranged in a function module 41, that can be laterally coupled to the sewing machine head 11, such that it can detect color marks 26 embodied on the pressure foot 21 and/or on the sewing needle 17. This color sensor 25 comprises a respective imaging optic 24 limiting the detection range to areas with color marks 26 on the sewing machine objects to be detected, connected to the sewing machine 1. For the sewing needle 17, this area may for example be determined for an upper position of the needle rod 13, which is used to exchange the sewing needle 17.

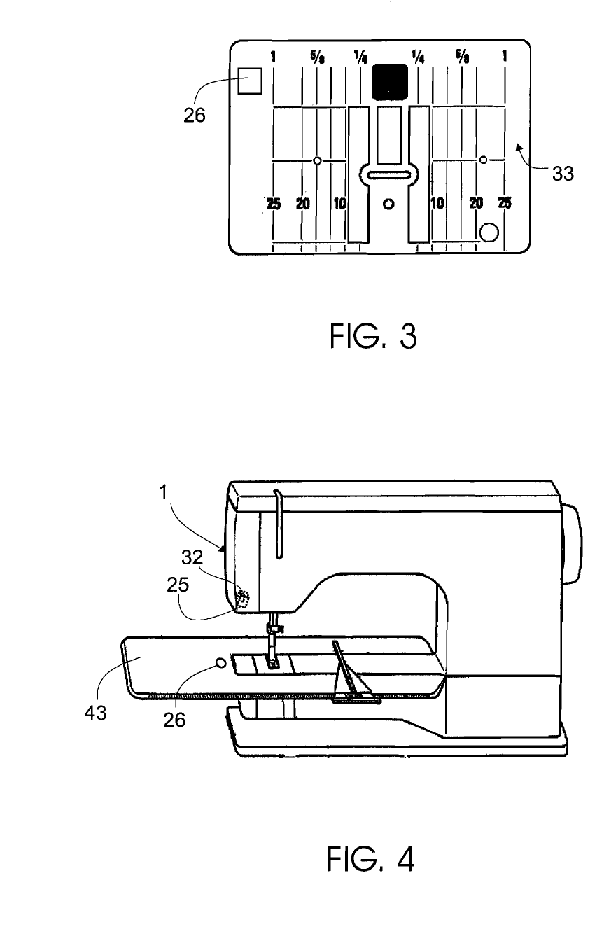

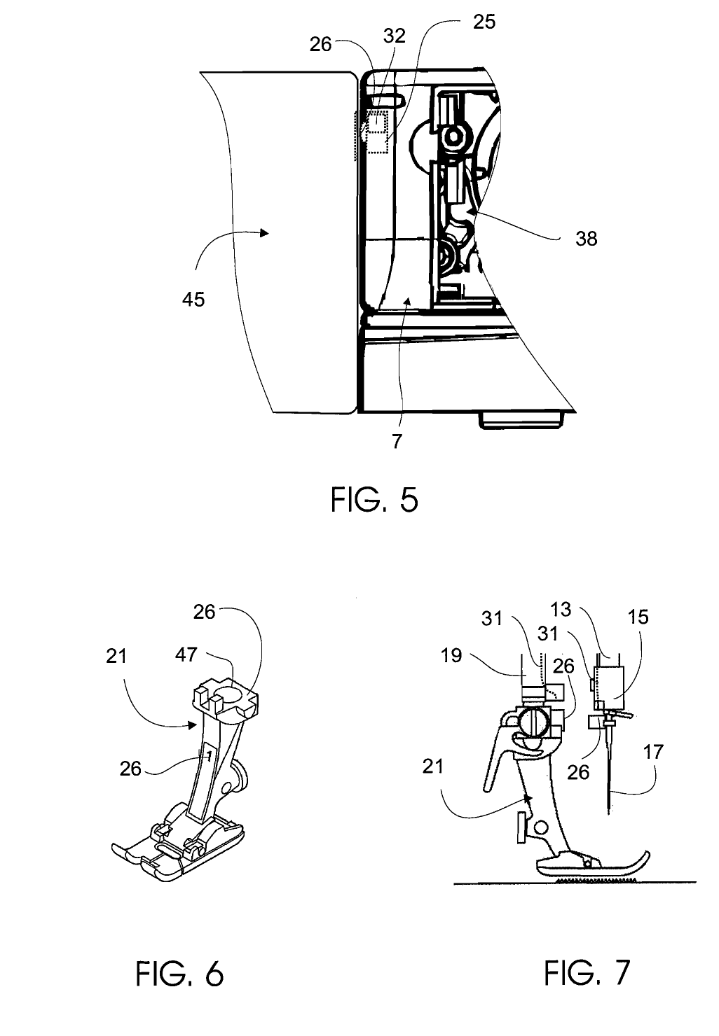

A color sensor 25 embodied at the sewing machine head 11 or at a function module 41, pointing downwards, may also be embodied for detecting the color of the sewing material (not shown) supported on the lower arm 7 or for detecting color marks 26 at the upper side of the stitching plate 33 (FIG. 3) and/or a sliding or sewing table 43 (FIG. 4) connected to the lower arm 7 to enlarge the sewing surface, or an embroidery module 45 (partial representation in FIG. 5). In order to prevent foreign objects from being detected in the intermediate space, when the distance between the color sensor 25 and the color mark 26 to be detected is very large, the detection may be triggered and/or confirmed by a user action, such as pushing an operator button 12. Alternatively, colors or color marks 26 can be arranged at the bottom or the side of such objects and be detected by color sensors 25 arranged at the lower arm 7, for example, as shown in FIG. 5. Preferably the color sensor 25 is arranged such that different sewing machine objects that can be coupled with the lower arm 7 having a color code 26 at the respective point can be detected.

The colors of the color marks 26 of the objects to be detected by a color sensor 25 are generally predetermined such that the color sensor 25 and/or the control effectively connected to the color sensor 25 can clearly identify the respective objects based on the detected colors.

Where no identical conclusion is possible by the detected color (e.g., when the color sensor 25 is used to detect the sewing material color, or when the detection of a color mark 26 is disturbed or prevented by a foreign object inside the detection area) the user may be asked, e.g., by a text or image display on the screen 10, to enter a more precise parameter or selection via the operating elements 12. Preferably the operating mode and/or the type of detection and processing of colors and color codes 26 can be influenced or predetermined interactively by the user via the color sensor or sensors 25. For example, it can be predetermined that the color sensors 25 by which color marks 26 clearly detect certain objects, can operate continuously, or that those color sensors 25 not producing any clear results have to be checked manually by pushing a button.

FIG. 6 shows a pressure foot 21, in which both the surface which encircle a spherical recess 47 for centering the counterpart of the pressure foot holder 19 as well as a colored alphanumeric code at the front can be used as color marks, depending how the detection area of the respective color sensor 25 is defined. The color sensor 25 can, e.g., be arranged in the sewing machine head 11, with the color marks 26 being detected by light conductors 31, integrated in the pressure foot holder 19 or mounted thereto (not shown).

Analogous thereto, the upper region of a sewing needle 17 can be marked with a color mark 26, which can be detected by a color sensor 25 in the sewing machine head 11 via the light conductor 31 integrated in the needle rod 13 or mounted thereto.

In FIG. 7 an arrangement is shown having a pressure foot 21 clamped to the pressure foot holder 19 and a sewing needle 17 inserted in the needle holder 15. The color marks 26 are mounted in the form of flag or button-shaped elements made from plastic in the upper region of the sewing needle 17 and/or the pressure foot 21. For fastening for example detachable snap-action connections can be used. For arranging the light conductor ends at the needle rod 13 and/or the pressure foot holder 19 immediately opposite the color marks 26 additional holding means can be provided.

For example, in general color marks 26 can be printed, adhered or in any other way applied directly to the respective object.

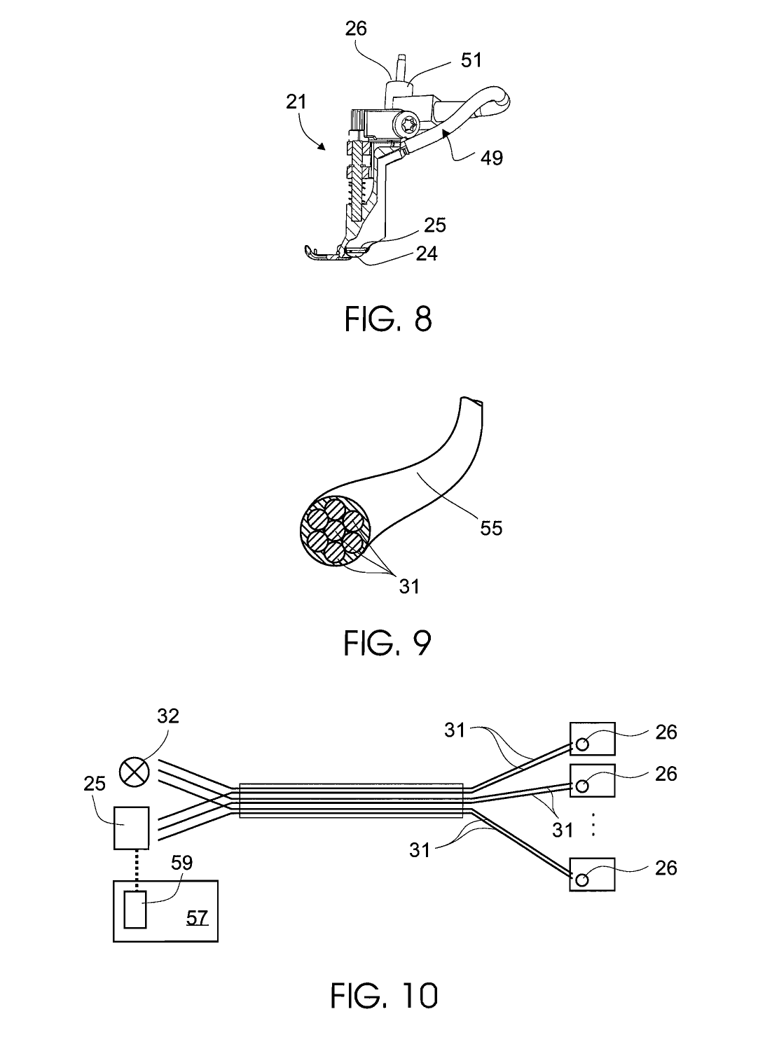

Color sensors 25 or allocated parts therefrom, such as e.g., light conductors 31 or imaging optics 24 can also be integrated partially or entirely in the accessories and/or sewing machine elements. FIG. 8 shows a pressure foot 21, in which the color sensor 25 and a downwards aligned lens and/or the detection optic 24 are integrated behind or next to the pressure foot sole in the pressure foot 21. The electric connection of the color sensors 25 occurs via a connection cable 49 to a plug 51, inserted into a corresponding plug 53 (FIG. 1) or coupling to the sewing machine head 11.

In another variant, only light conductors 31 and perhaps coupling and decoupling elements, such as optical lenses and mirrors, are integrated in the pressure foot 21, and the color sensor 25 is in this case arranged in the machine head 11. The optic connection of the light conductor 31 in the pressure foot 21 with the color sensor 25 and/or additional light conductors 31 connected to the color sensor 25 can e.g., occur via a coupling site in the area of the conical recess 47 (not shown) or via a connection cable 49 using an optic plug connection (analogue to power supply cables 49).

In general, the coding of all optic or electric connections of accessories with the sewing machine 1 is possible via color marks 26, with in the area of the interface of the accessories, i.e. at the face of the covers of the connection plugs 51, e.g., color marks 26 are arranged, and with at the part of said interface facing the sewing machine corresponding elements of the detection device are embodied, such as e.g., the ends of light conductors 31 connected to a color sensor 25.

FIG. 9 shows symbolically a section of a fiber optic with several multi-modal glass fiber-light conductors 31 combined to a bundle, which are coated by a protective sleeve 55. Such fiber optics generally comprise a multitude of individual glass or plastic fibers. For reasons of better clarity in FIG. 9 only few of these fibers are shown.

One or more of the light conductors 31 can be used for lighting color marks 26 at the end of the optic fiber bundle via the light source 32 at the machine (FIG. 10). The light source 32 comprises here a frequency spectrum which is sufficient to detect and identify all colors of the color marks 26 used. The remaining light conductors 31 serve to guide light, reflected and/or diffused at the color marks 26 inside the respective detection area at the end of said light conductors 31 to the respectively allocated color sensor 25. The light is not necessarily coming from a light source 32 specially provided for illuminating the color marks 26. Depending on the arrangement of the color marks 26 the ambient light and/or daylight can also be sufficient.

Fiber bundles can also be spliced into individual partial strands at one side or at both. This way several color marks 26 can detect various objects positioned at different locations using only a single color sensor 25. Such an arrangement is schematically shown in FIG. 10.

The color sensor or sensors 25 each comprise an output interface, which e.g., comprise one channel for red, green, and blue components each or alternatively a digital communications channel. This way the color sensors 25 are in an effective connection (shown in FIG. 10 schematically as dot-dash line) to a parameter memory for colors, memory 59 for short. The memory 59 can be the sewing machine control 57, for example. Alternatively, such a memory 59 may also be included in the electronic of the color sensor 25. Reference values for the colors and/or color features can be stored in the memory 59 by being predetermined in the sewing machine control 47, for example. Alternatively a learning mode may be activated with the color features detected by the color sensor 25 being saved in the memory 59 as reference or comparison values. The saved reference values are always allocated precisely to the respective object. This can occur, for example, in form of a look-up table, with object features and/or features clearly identifying the respective object being stored (e.g., identification number), referenced to the data of color features of these objects and/or the color features 26 allocated to the objects.

The sewing machine control 57 constantly or upon a respective instruction of the user controls the signals of the color sensors 25 and this way detects the sewing machine objects connected to the sewing machine 1. A program of the sewing machine control 57 evaluates the information of the color sensors 25 and executes suitable measures depending on the objects connected to the sewing machine 1 or certain combinations of such objects.

Such measures (not limited to the ones listed) are for example:
displaying the connected sewing machine objects on display 10
acoustic and/or optic warning in case of potential conflicts (e.g., warning sound or synthetic voice)
blocking the sewing process in case of danger (e.g., when using a sewing needle 17, which is not compatible to the inserted stitching plate 33)
adjusting motion areas where necessary (e.g., maximum permissible pivotal range of the needle rod 13 is determined depending on the sewing needle 17 inserted in the needle holder and the stitching plate 33 used)
adjusting the menu control (e.g., release of the selection of certain stitching or knitting pattern depending on the pressure foot 21 connected to the pressure foot holder 19 and the knitting module 45 connected to the sewing machine 1)
displaying information (e.g., request to insert a suggested selection of sewing needles 17 into the needle holder 15 when a certain stitching plate 33 is used)
configuring an interface depending on the objects connected thereto (e.g., a bushing 53 at the sewing machine head 11 can be used for connecting a pressure foot 21 with integrated color sensors 25 or a pressure foot 21 with a sensor for detecting the relative motion of the sewing material as necessary for free-hand quilting to control the needle rod motion).

With an appropriate arrangement, the color sensors 25 can also be used for detecting and supervising sewing elements. For example, the colors of the lower thread can be detected on the lower thread bobbin 29 in the hook housing 38 and the upper thread of an upper thread spool placed onto a thread spool holder 34 as well as the color of the sewing material from the bottom in the area of the stitching plate 33. If the three colors detected are not matching within predetermined tolerance limits e.g., a warning can be shown at the display 10. If the color sensor 25 detects a second color with increasing intensity at the lower thread bobbin this indicates an end section of a thread with a different color. However, when the intensity of the lower thread used slowly reduces this indicates an upcoming end of the thread. The lower thread bobbin 29 may also indicated a certain color on the interior. In this way, disturbing reflections are avoided. The upcoming end of the thread can in this case be determined by a slow transfer of the color from the thread color to the color of the lower thread bobbin detected by the color sensor 25.

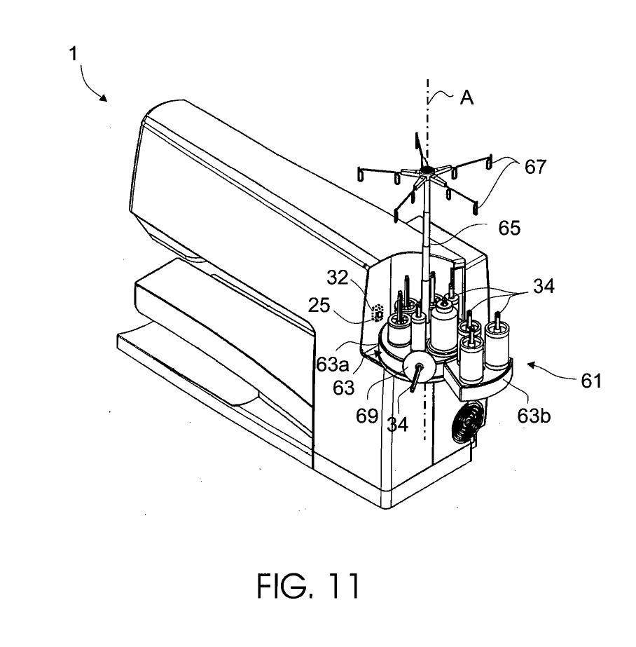

FIG. 11 shows another embodiment of the device according to the invention on a sewing machine 1 with a thread spool carousel 61, as particularly suitable for executing embroidering tasks using a sewing machine 1. This comprises a preferably motorized base plate 63 rotary or pivotal around a rotary axis A, which can be positioned at different angles via a control device, e.g., via the sewing machine control 57. The base plate 63 has essentially the form of a circular disc 63a. A section of an arc 63b and/or satellite can be connected to the periphery of the disc 63a and e.g., be shifted along this periphery along a guide. The disc 63a can therefore also be further rotated even when the section of the arc 63b contacts the sewing machine housing. At the base plate 63, a telescopically embodied cantilever 65 extends upwards along the pivotal axis A. At its tip, several thread guiding members 67 are provided. Coaxially to the rotary axis A, several thread spool pins and/or thread spool holders 34 protrude upwards from the base plate 63. At the disc 63a and at the arc sections 63b additional thread spool holders 34 can be embodied. In FIG. 11 one of the thread spool holders 34 is arranged on a holding plate 69 pivotal in reference to the base plate 63 such that a thread is pulled off a thread spool on this thread spool holder 34 through one of the eyes of a thread guiding member 67 tangentially in reference to the thread spool, extending approximately perpendicular to the thread spool holder 34.

A color sensor 25 including the light source 32 is arranged laterally in reference to the thread spool carousel 61 is to be arranged in a recess at the holder 5 of the sewing machine 1 such that the thread color of each thread spool can be detected is placed on the nearest thread spool holder 34 within the detection range of the color sensor 25. Depending on the rotary position of the thread spool carousel 61 all thread colors of the thread spools can be detected which is placed onto the thread spool holder 34 extending upwards onto the disc 63a. For example, the color sensor 25 and the light source 32 can also be arranged at the cantilever 65 in a locally fixed manner or in a different manner, e.g., mobile in reference to the sewing machine 1. In order to detect all thread colors, several color sensors 25 may also be used (not shown). In an alternative embodiment, a light guiding optic is embodied in each thread spool holder 34 which can be used for detecting the color of the thread spool (not shown) placed on the respective thread spool holder 34. The detection of the thread color is thus depending on the rotary position of the thread spool carousel 61.

Using such devices, the control of the sewing machine 1 can execute for example the following tasks: detecting the colors of the thread spools placed on the thread spool holder 34; storing the detected colors referenced to the data for the respective thread spool holder 34 or the respective rotary position of the thread spool carousel 61; searching an upper thread color matching the color of the sewing material; automatic thread exchange with control of the thread color.

In another embodiment of the invention, a color sensor 25 arranged in the area of the sewing machine head 11 and detecting the sewing material in the area of the stitching place of the sewing machine 17 can also be used for detecting the illumination and the regulation of the brightness of a sewing light (not shown).

Using the device according to the invention and the process according to the invention, safety is increased, mistakes are prevented, the operation is facilitated, and/or automated and the quality can be improved during the operation of the sewing machine 1.

### LIST OF REFERENCE CHARACTERS

1 sewing machine
3 base
5 stand
7 lower arm
9 upper arm
10 display
11 sewing machine head
12 operating elements
13 needle rod
15 needle holder
17 sewing needle
19 pressure foot holder
21 pressure foot
23 threading device
25 color sensors
26 color marks
27 thread winding device
29 lower thread bobbin
31 light conductor, optic fiber bundle
32 light source
33 stitching plate
34 thread spool holder
35 hook
37 flap
38 hook housing
39 bobbin capsule
41 function module
43 sewing table
45 embroidery module
47 conical recess
49 connection cable
51 plug
53 bushing
55 protective sleeve
57 sewing machine control
59 memory
61 thread bobbin carousel
63 base plate
63a disc
63b section of the arc
65 cantilever
67 thread guiding organ
69 holding plate

1. A device for detecting objects on sewing machines (1), with the objects to be detected being illuminated, comprising at least one color sensor (25) adapted to detect color features of the objects and/or color marks (26) arranged on the object at one or more detection areas, and the color sensor (25) includes at least an output for displaying color features of the detected objects and/or color marks.

2. A device according to claim 1, further comprising a memory for storing reference criteria for the color features detected by the color sensor (25).

3. A device according to claim 1, further comprising at least one light source (32) for illuminating the objects inside the detection area or areas of the color sensor (25).

4. A device according to claim 1, wherein the color sensor (25) is arranged on or in a sewing machine housing such that a sewing machine object, detachably coupled or connected correctly to the sewing machine (1) and/or a color mark (26) applied on the sewing machine object is located at least partially within the detection area of the color sensor (25).

5. A device according to claim 1, further comprising light wave conductors (31) connected or effectively connected to the color sensor (25) or other optic transmission means, that define one or more detection areas for the color sensor (25) and the detection area or areas are arranged such that the color marks (26) of the sewing machine objects correctly coupled or connected to the sewing machine (1) are at least partially located inside the respective detection areas of the color sensor (25).

6. A device according to claim 3, wherein the light source (32) is connected or effectively connected to light wave conductors (31) or other optic transmission means in order to conduct light from the light source (32) to the detection area or areas.

7. A device according to claim 1, wherein the color sensor (25) and/or optic transmission means for creating an effective connection to the color sensor (25) is at least partially integrated in the sewing machine object or mounted to the sewing machine object.

8. A device according to claim 1, wherein at least one of the detection areas is arranged at a bushing (53) for connecting a plug (51).

9. A device according to claim 1, further comprising sewing machine objects that can be detachably connected or coupled to the sewing machine (1) including a color mark (26) clearly referenced to the respective sewing machine object.

10. A method for detecting objects in sewing machines (1) with the objects to be detected being illuminated, comprising detecting color features of the objects and/or color marks (26) thereon within a detection area using a color sensor (25), comparing the detected color features to saved reference criteria, and generating display data when the detected color features are congruent within a predetermined tolerance range of the saved reference criteria, which is clearly referenced to the respective object.

11. A method according to claim 10, wherein depending on the objects detected by the color sensor or sensors (25), giving a warning and/or restricting an effective area and/or adjusting menu items of a user menu.

12. A method according to claim 10, wherein the objects are thread spools placed onto thread spool holders (34) or threads wound on the lower thread bobbins (29), and colors of the thread bobbins or threads are detected and control of the sewing machine (1) occurs depending on the colors detected.
